(19) United States
(12) Patent Application Publication
(10) Pub. No.: US 2015/0227897 A1
(43) Pub. Date: Aug. 13, 2015

(54) Method of Making, Securing, and Using a Cryptocurrency Wallet

(71) Applicant: ANTHONY LOERA, Miami, FL (US)

(72) Inventor: ANTHONY LOERA, Miami, FL (US)

(21) Appl. No.: 14/178,234

(22) Filed: Feb. 11, 2014

(51) Int. Cl. G06Q 20/06

(52) U.S. Cl. CPC G06Q 20/065

(57) ABSTRACT

A method of making, securing, and using a tangible Cryptocurrency wallet, wherein the tangible Cryptocurrency wallet is a printable medium that displays a public key that is in visible ink and that conceals a private key in invisible ink. The tangible Cryptocurrency wallet can be used in public by the user, for the private key can only be disclosed by the owner of the tangible Cryptocurrency wallet when the owner illuminates the private key with a light source that has a specific wavelength. The tangible Cryptocurrency wallet is a wallet that can be made of paper or of any material in which visible and invisible ink can be recorded.

### BACKGROUND

The present invention relates to a method of making, securing, and using a tangible Cryptocurrency wallet.

Cryptocurrency is a distributed peer-to-peer digital currency that can be transferred instantly and securely between any two people in the world. It's similar to electronic cash that can be used to pay third parties.¹ Bitcoin is a cryptocurrency and it is the first decentralized peer-to-peer payment network that is powered by its users with no central authority or middlemen. ¹ https://en.bitcoin.it/wiki/FAQ#What is Bitcoin.3F

Bitcoins (all letters in lower case) are the unit of currency of the Bitcoin system. A commonly used shorthand for this is “BTC” to refer to a price or amount (e.g. “200 BTC”). There are such things as physical bitcoins, but ultimately, a bitcoin is just a number associated with a Bitcoin address. A physical bitcoin is simply an object, such as a coin or a business card, with the number carefully embedded inside either as an alphanumeric character or as a QR code that represents the alphanumeric character.

The bitcoin has a public key (the address) and a private key. The public key can be seen by others to verify the quantity of the currency at the specific address. The currency at the address can only be transferred to a third party by disclosing the private key.

A private key in the context of Bitcoin is a secret number that allows bitcoins to be spent. Every Bitcoin address has a matching private key, which is saved in the wallet file of the person who owns the balance. The private key is mathematically related to the Bitcoin address, and is designed so that the Bitcoin address can be calculated from the private key, but importantly, the same cannot be done in reverse.² Private keys must be kept securely, for they authorize the release of bitcoins at a specific address. ² https://en.bitcoin.it/wiki/Private key

Private keys can be kept on computer files (digital wallet), but they are also short enough that they can be printed on paper. The danger of only keeping a private key on a digital wallet is that if the device that holds the private key is destroyed or compromised, the private key will be lost forever and the public key will not be able to be accessed. The currency held at the address will never be released from the address to a third party and the bitcoins in the address will be lost.

A paper wallet is a mechanism for storing bitcoins offline as a physical document that can be secured like paper money. Paper wallets are generally created by printing a brand new public address and private key onto paper, and then sending bitcoins from a “live” wallet to the printed wallet's public address for safekeeping.

The advantage of using a paper wallet is that you can disclose to a third party the amount of currency at a specific Bitcoin address when bartering a deal, the danger is that if you accidentally disclose the private key to the third party, the third party will be able to transfer the currency to a new address. In the same manner, if you lose the paper in which the public and private keys are stored, a third party will be able to transfer the funds from the public key. If good security practices are followed, paper wallets are one of the safest ways to store bitcoins.³ ³ https://en.bitcoin.it/wiki/Paper wallet

In this application, the term Cryptocurrency shall be used in the same manner Bitcoin, the term Cryptocurrency address in the same manner is Bitcoin address, the term Cryptocurrency wallet in the same manner as Bitcoin wallet, and the term cryptocoin (s) in the same manner as bitcoin (s)

For the foregoing reasons there is a need for a method of making, securing, and using a tangible Cryptocurrency wallet.

### SUMMARY

The present invention is directed to a method of making, securing, and using a tangible Cryptocurrency wallet.

In an embodiment of the present invention, the method of making, securing, and using a tangible Cryptocurrency wallet comprises the steps of providing an inkjet printer that uses visible and invisible ink; providing a computing device capable of sending a print signal to the inkjet printer, obtaining a Cryptocurrency address and private key on the computing device from a Cryptocurrency network; providing a printable medium, then loading the printable medium in the inkjet printer, sending a first print instruction to the inkjet printer, wherein the print instruction is to print the public key on the printable medium in visible ink; and sending a second print instruction to the inkjet printer, wherein the print instruction is to print the private key on the printable medium in invisible ink.

In another embodiment of the present invention, the method further comprises of providing a light source that illuminates the private key so that it is readable to a human.

An object of the present invention is to provide a tangible Cryptocurrency wallet that manifests a public key in visible ink and conceals a private key in invisible ink.

Another object of the present invention is to provide a tangible Cryptocurrency wallet that can be shown to third parties so that the amount of currency on the wallet can be verified and yet the private key is not visibly displayed.

Still another object of the present invention is to provide a tangible Cryptocurrency wallet that can be transferred to third parties while maintaining the private key concealed from other third parties.

### DRAWINGS

With the above and other related objects in view, the invention consists in the details of construction and combination of parts as will be more fully understood from the following description, when read in conjunction with the accompanying drawings in which:

FIG. 1 shows the first side a tangible Cryptocurrency wallet, wherein the first side displays a Cryptocurrency public key/address;

FIG. 2 shows the second side of a tangible Cryptocurrency wallet, wherein the second side conceals a Cryptocurrency private key; and

FIG. 3 shows the second side of a tangible Cryptocurrency wallet, wherein the second side reveals the Cryptocurrency private key when it is illuminated by a light source having a certain light wave frequency.

### DESCRIPTION

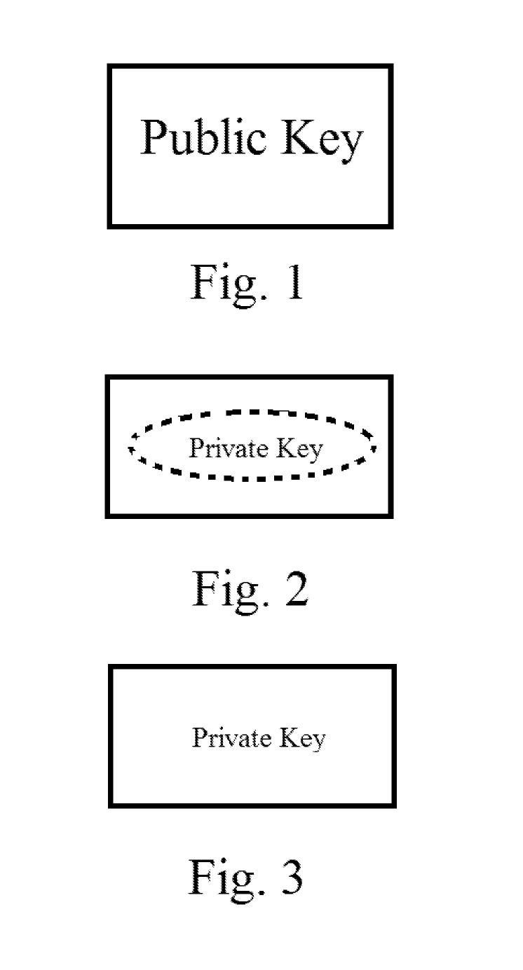

As seen in FIGS. 1-3, an embodiment of the present invention discloses a tangible Cryptocurrency wallet that is made, secured, and used as follows. A method of making, securing, and using a tangible Cryptocurrency wallet comprising: providing a printer that uses visible and invisible ink; providing a computing device capable of sending a print signal to the printer; obtaining a Cryptocurrency address and private key on the computing device from a Cryptocurrency network, providing a printable medium, then loading the printable medium in the printer; sending a first print instruction to the inkjet printer, wherein the print instruction is to print the public key on the printable medium in visible ink; and sending a second print instruction to the printer, wherein the print instruction is to print the private key on the printable medium in invisible ink.

In another embodiment of the present invention, the method further comprising providing a light source that illuminates the private key so that it is readable to a human.

In yet another embodiments of the present invention, the order in which the visible and invisible ink is placed on the printable medium may be alternated.

In still another embodiment of the present invention, the printer is an inkjet printer.

An advantage of the present invention is that it provides a tangible Cryptocurrency wallet that manifests a public key in visible ink and conceals a private key in invisible ink.

Another advantage of the present invention is that it provides a tangible Cryptocurrency wallet that can be shown to third parties so that the amount of currency on the wallet can be verified and yet the private key is not visibly displayed.

Still another advantage of the present invention is that it provides a tangible Cryptocurrency wallet that can be transferred to third parties while maintaining the private key concealed from other third parties.

Although the present invention has been described in considerable detail in reference to preferred versions, other versions are possible. Therefore, the spirit and scope of the appended claims should not be limited to the description of the preferred versions contained herein.

What is claimed is:

1. A method of making, securing, and using a tangible Cryptocurrency wallet comprising:
providing a printer that uses visible and invisible ink;
providing a computing device capable of sending a print signal to the printer;
obtaining a Cryptocurrency address and private key on the computing device from a Cryptocurrency network;
providing a printable medium, then loading the printable medium in the printer;
sending a first print instruction to the inkjet printer, wherein the print instruction is to print the public key on the printable medium in visible ink; and
sending a second print instruction to the printer, wherein the print instruction is to print the private key on the printable medium in invisible ink.

2. The method of making, securing, and using a tangible Cryptocurrency wallet of claim 1, further comprising providing a light source that illuminates the private key so that it is readable to a human.

3. The method of making, securing, and using a tangible Cryptocurrency wallet of claim 2, wherein the order in which the visible and invisible ink is placed on the printable medium may be alternated.

4. The method of making, securing, and using a tangible Cryptocurrency wallet of claim 3, wherein the printer is an ink jet printer.

5. The method of making, securing, and using a tangible Cryptocurrency wallet of claim 1, wherein the order in which the visible and invisible ink is placed on the printable medium may be alternated.

6. The method of making, securing, and using a tangible Cryptocurrency wallet of claim 5, wherein the printer is an ink jet printer.
